(19) United States
(12) Patent Application Publication
(10) Pub. No.: US 2015/0250145 A1
(43) Pub. Date: Sep. 10, 2015

(54) DOG DIAPER SECURING DEVICE

(71) Applicant: Cheryl Anne Sulicz, Sauget, IL (US)

(72) Inventor: Cheryl Anne Sulicz, Sauget, IL (US)

(21) Appl. No.: 14/198,565

(22) Filed: Mar. 5, 2014

(51) Int. Cl. A01K 27/00; A01K 23/00

(52) U.S. Cl. CPC A01K 27/002; A01K 23/00

(57) ABSTRACT

A dog diaper securing device may include a webbing. The webbing may have a first end and a second end. The first end of the webbing may have a first fastener attached to the end. The second end of the webbing may have a second fastener attached to the end. A buckle may be attached to the webbing. At least one belt keeper may be attached to the webbing.

### BACKGROUND OF THE INVENTION

The present invention relates to dog diapers and, more particularly, to a dog diaper securing device.

Currently, when a dog is required to wear diapers there are several products that claim to resolve the issue of the diapers falling off the dog. However, the products are made from flimsy cotton fabrics that wear quickly and become unsightly. The connection piece used currently comes loose from the diaper allowing it to slide off the dog.

As can be seen, there is a need for a dog diaper securing device that forms and holds the device securely to the dog and is adjustable.

### SUMMARY OF THE INVENTION

In one aspect of the present invention, a dog diaper securing device comprises: a webbing having a first end and a second end; and at least one fastener attached to the first end of the webbing, and at least one fastener attached to the second end of the webbing.

In another aspect of the present invention, a dog diaper securing device comprises: a webbing having a first end and a second end; a buckle attached to the webbing; two belt keepers attached to the webbing; and two fasteners attached to the first end and the second end of the webbing.

In another aspect of the present invention, a method for securing a diaper on a dog comprises: placing a diaper on a dog; placing a dog diaper securing device on the dog, wherein the dog diaper securing device is defined as a webbing having a first end, a second end, and at least one fastener attached to the first end of the webbing, and at least one fastener attached to the second end of the webbing; and attaching the fasteners of the dog diaper securing device on the diaper that is on the dog.

These and other features, aspects and advantages of the present invention will become better understood with reference to the following drawings, description and claims.

### BRIEF DESCRIPTION OF THE DRAWINGS

FIG. 1 is a front view of an exemplary embodiment of the present invention shown in use;

FIG. 2 is a rear view of an exemplary embodiment of the present invention shown in use; and

FIG. 3 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a dog diaper securing device may include a webbing. The webbing may have a first end and a second end. The first end of the webbing may have a first fastener attached to the end. The second end of the webbing may have a second fastener attached to the end. A buckle may be attached to the webbing. At least two belt keepers may be attached to the webbing.

The present invention may include quality printed webbing that may be sturdy, wears well, may be washable, and presents a clean, finished appearance. The present invention may wrapped and secured around a dog, while attaching to a diaper that the dog is wearing, so that the diaper may be securely in place on the dog while in use.

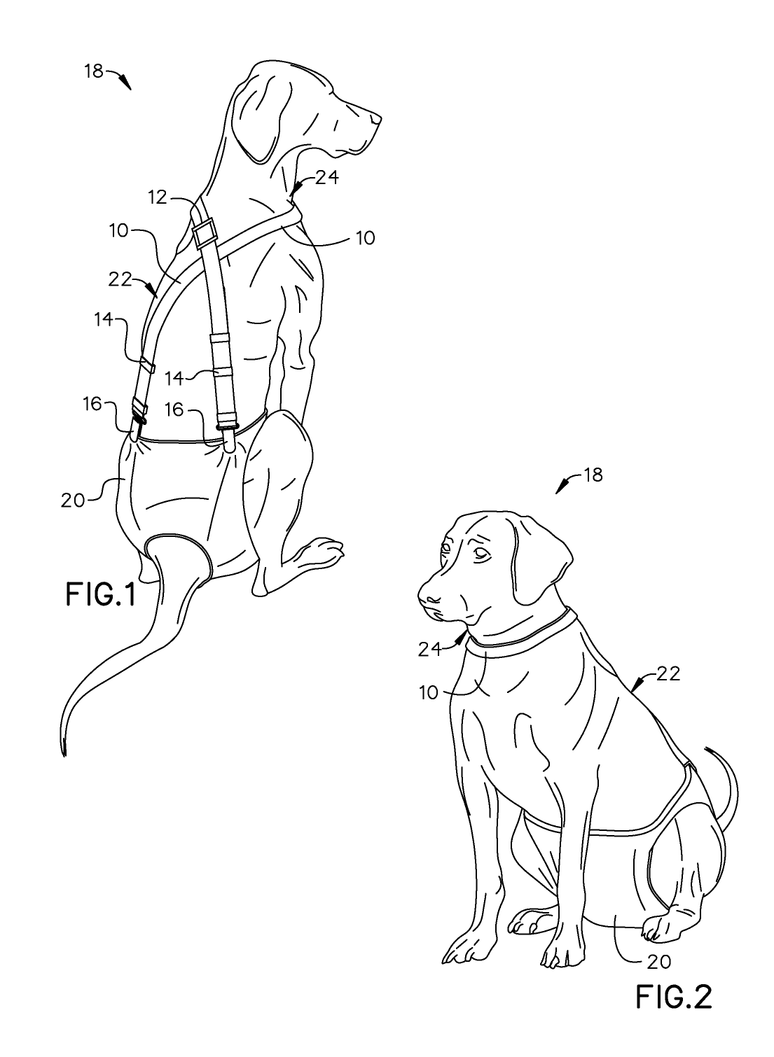

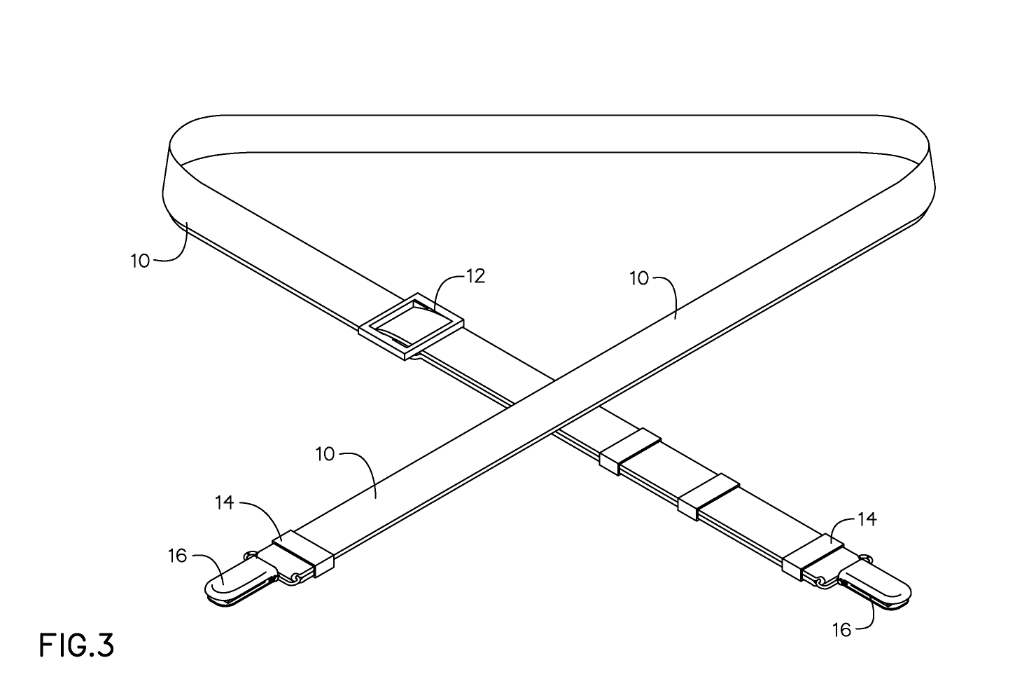

As is illustrated in FIGS. 1 through 3, the dog diaper securing device may include a webbing 10. The webbing 10 may include a first end and a second end. At least one fastener 16 may be attached to the first end and the second end of the webbing 10. A buckle 12 may be attached to the webbing 10. In certain embodiments, a plurality of belt keepers 14 may be attached to the webbing 10.

In certain embodiments, the webbing may be made from polyester or the like. In certain embodiments, the webbing may be approximately one inch in width. The buckle 12 may be made from a plastic or the like.

A method of making the dog diaper securing device may include the following. A person may wrap a tape measure around the opposite side of the dog's 18 neck and continue around the chest of the dog 18 and come back up the opposite side of the dog's neck. The person may then crisscross the tape measure across the dog's back and finish the measurement on the opposite side of the diaper back from where the measurement began. The person may add an additional approximately 15 inches to this measurement to allow for looping through the buckle and webbing fasteners 16. The webbing 10 may then be cut to a desired length using a webbing cutter. The individual may then loop one end of the webbing 10 around the center of the buckle 12 and secure by stitching or the like. The individual may then place a plurality of belt keepers 14 on the webbing 10. The person may then loop the end of the webbing through the fastener 16 and back through the plurality of belt keepers 14. The webbing may then be inserted into the buckle 12. Another belt keeper 14 may be placed on the webbing. The person may loop the webbing 10 through another fastener 16 and secure by stitching or the like. The fastener 16 may be a suspender type clip or the like that pinches the diaper 20 in order to help secure the diaper 20 to the dog 18.

A method of using the dog diaper securing device may include the following. After a diaper 20 is placed on the dog 18, removably attach a first fastener 16 to the back of the diaper 20 just off center. The fastener 16 may pierce the diaper 20 for a stronger, more secure hold. The webbing 10 may be wrapped around the front of the neck region 24 of the dog 18 and brought back around to the back region 22. The webbing 10 may be crisscrossed along the back region 22 of the dog 18. The small end of the webbing 10 may be inserted into the buckle 12. The buckle 12 may slide up along the webbing 10 and hold the crisscross form along the back region 22 of the dog 18. The second fastener 16 may be removably attached to the diaper 20 along the back on the opposite side of the first fastener 16. The dog diaper securing device may be used to keep the diaper 20 from slipping off the dog 18. Once the dog diaper securing device may be placed on the dog 18, the webbing 10 may be adjusted for a comfortable fit by arranging the buckle 12.

It should be understood, of course, that the foregoing relates to exemplary embodiments of the invention and that modifications may be made without departing from the spirit and scope of the invention as set forth in the following claims.

What is claimed is:

1. A dog diaper securing device comprising:
a webbing having a first end and a second end; and
at least one fastener attached to the first end of the webbing, and at least one fastener attached to the second end of the webbing.

2. The dog diaper securing device of claim 1, wherein the at least one fastener comprises two fasteners.

3. The dog diaper securing device of claim 1, wherein the webbing is polyester.

4. The dog diaper securing device of claim 1, wherein the at least one fastener is at least one suspender type clip with teeth.

5. A dog diaper securing device comprising:
a webbing having a first end and a second end;
a buckle attached to the webbing;
a plurality of belt keepers attached to the webbing; and
a first fastener attached to the first end of the webbing and a second fastener attached to the second end of the webbing.

6. The dog diaper securing device of claim 5, wherein the plurality of belt keepers comprises two belt keepers.

7. A method for securing a diaper on a dog comprising:
placing a diaper on a dog;
placing a dog diaper securing device on the dog, wherein the dog diaper securing device is defined as a webbing having a first end, a second end, and at least one fastener attached to the first end of the webbing, and at least one fastener attached to the second end of the webbing; and
attaching the fasteners of the dog diaper securing device on the diaper that is on the dog.

8. The method of claim 7, wherein the at least one fastener comprises two fasteners.

9. The method of claim 7, wherein the webbing is polyester.

10. The method of claim 7, wherein the at least one fastener is at least one suspender type clip with teeth.
